(19) United States
(12) Patent Application Publication
(10) Pub. No.: US 2008/0162848 A1
(43) Pub. Date: Jul. 3, 2008

(54) CONTROLLING ACCESS TO A MEMORY REGION

(75) Inventors: Paul J. Broyles, Cypress, TX (US); Louis B. Hobson, Tomball, TX (US); Mark A. Piwonka, Tomball, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/618,822

(22) Filed: Dec. 30, 2006

(51) Int. Cl. G06F 12/00

(52) U.S. Cl. 711/163; 711/E12.001

(57) ABSTRACT

A method of and controller for controlling access to a memory region are described. The method comprises driving an unlock signal to an input line based on an unlock value in a lock state memory and restarting a computer system after writing an unlock value to a lock state memory. The unlock value is read from the input line and access to the memory region based on the read unlock value is enabled.

### BACKGROUND

FIG. 1 depicts a functional block diagram of a portion of a computer system 100. In particular, FIG. 1 depicts a portion of a motherboard 102 of computer system 100. Motherboard 102 comprises a processor 104, a memory controller hub 106 connected to the processor, an input/output (I/O) controller hub 108 connected to the memory controller hub, a general purpose I/O (GP I/O) 110 connected to the I/O controller hub, and a non-volatile (NV) memory 112 connected to the I/O controller hub. Memory controller hub 106, e.g., an integrated circuit referred to as a Northbridge, communicates with memory such as random access memory (RAM), I/O controller hub 108, display systems such as video cards, and processor 104. I/O controller hub 108, e.g., an integrated circuit referred to as a Southbridge, communicates with memory controller hub 106, NV memory 112, and GP I/O 110.

GP I/O 110 comprises a set of input/output lines 112₁ . . . 112_{N} for receiving and/or transmitting signals. NV memory 112, e.g., a flash-based memory, stores parameters accessed by various systems of motherboard 102, e.g., computer system basic input/output system (BIOS) parameters, network controller settings, etc. NV memory 112 comprises a descriptor table 116 which stores access rights for determining whether a particular component, e.g., processor 104, memory controller hub 106, I/O controller hub 108, etc., is able to access and/or modify particular stored parameters. For example, a particular region of descriptor table 116 may specify that processor 104 is able to read and write a particular memory region in NV memory 112 containing parameters related to operation of the processor and another region may specify that a video card is able to read and write a second memory region in NV memory while disallowing write access to the processor. During startup of computer system 100, I/O controller hub 108 reads descriptor table 116 in order to control access to particular memory regions in NV memory 112 by computer system components. In order to be able to modify, e.g., for service and/or maintenance of computer system 100, NV memory 112 contents for more than one component, each component needs to update the particular memory region related to the component.

An approach to avoid requiring access by each component to modify the particular memory region of that component involves causing the I/O controller hub 108 to not read the access rights specified in descriptor table 116. During startup of computer system 100, I/O controller hub 108 reads at least one of I/O lines 112 prior to reading descriptor table 116 in order to detect whether one or more of the I/O lines receives a signal (“unlock” signal) thereby causing the I/O controller hub to not apply the specified access rights to requests to modify NV memory 112.

In order to modify the contents of NV memory 112 without regard to specified access rights, if I/O controller hub 108 detects a signal on a particular I/O line 112₁, the I/O controller hub does not read the access rights stored in descriptor table 116 and enables reading and/or writing of memory regions in NV memory 112 by components otherwise lacking access rights according to the descriptor table. According to this approach, a jumper 118, e.g., an electrically conductive component such as a wire or other signal conducting device, is applied across two GP I/O lines, i.e., an input line 112₁ and an output line 112₂. Output line 112₂ is selected as a line driving a signal at startup time which is redirected to input line 112₁ to cause I/O controller hub 108 to detect the unlock signal and not read the access rights specified in the descriptor table 116.

In some embodiments, installation of jumper 118 to output line 1122 and input line 1121 causes I/O controller hub 108 to read the specified access rights in descriptor table 116; however, subsequent requests to read and/or modify particular memory regions in NV memory 112 controlled by the access rights are executed without regard to the specified access rights.

Removal of jumper 118 and restarting computer system 100 causes I/O controller hub 108 to read the access rights stored in descriptor table 116 and control access to specified memory regions in NV memory 112 by requesting components. Installation and removal of jumper 118 requires a user to gain internal access to computer system 100 and correctly place the jumper with respect to GP I/O lines 112.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a functional block diagram of a portion of a computer system;

FIG. 2 is a functional block diagram of a portion of a computer system according to an embodiment; and

FIG. 3 is a process flow diagram of operation of an embodiment.

### DETAILED DESCRIPTION

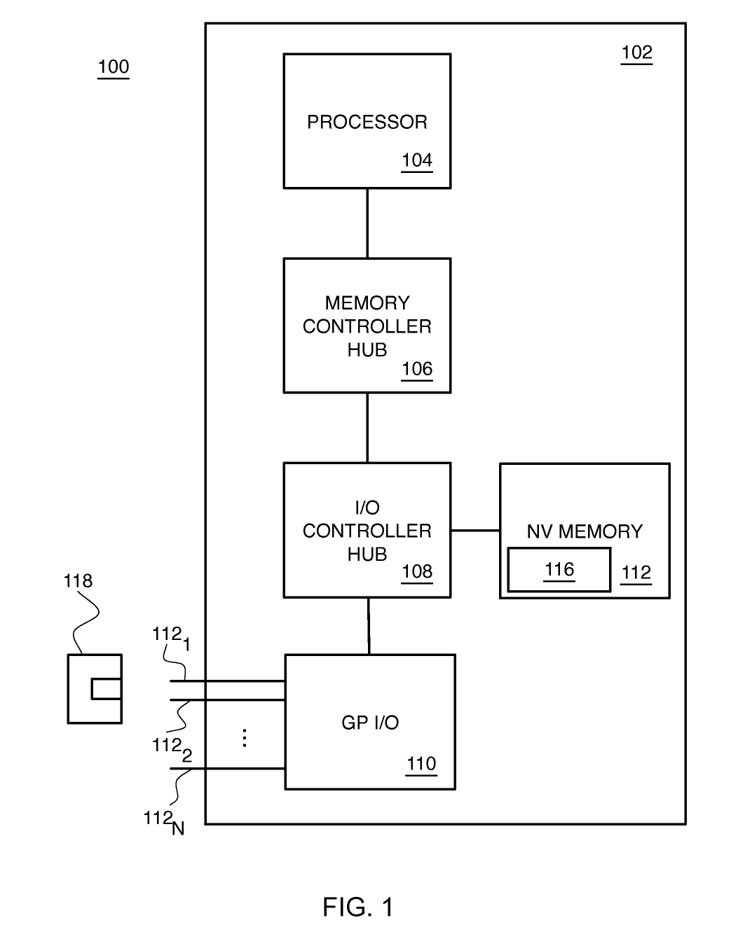

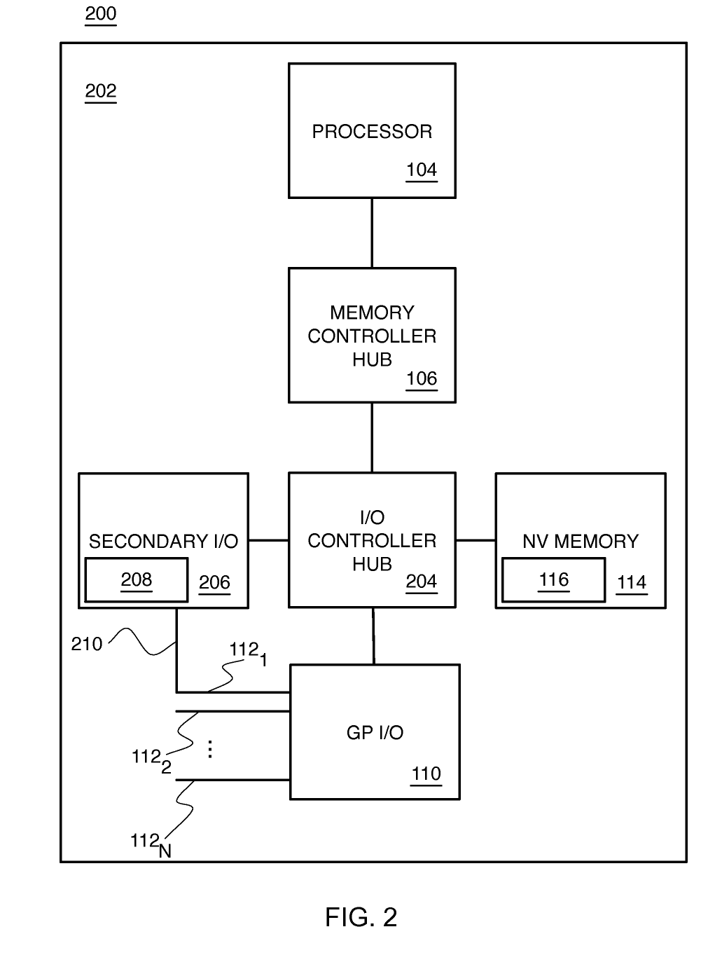

FIG. 2 depicts a functional block diagram of a portion of a computer system 200 and a portion of a motherboard 202 of the computer system. Motherboard 202 comprises processor 104, memory controller hub 106, GP I/O 110, and NV memory 114. NV memory 114 comprises a descriptor table 116. Motherboard 202 additionally comprises an I/O controller hub 204 communicatively coupled with memory controller hub 106, NV memory 114, GP I/O 110, and a secondary I/O 206. I/O controller hub 204 operates similar to I/O controller hub 108 (FIG. 1) to control access to memory regions of NV memory 114 based on access rights specified in descriptor table 116.

Secondary I/O 206 provides an additional input/output communication capability to motherboard 202, and more specifically to I/O controller hub 204. In some embodiments, secondary I/O 206 is a class of I/O controller integrated circuits, e.g., Super I/O, which provides a communication ability with respect to low bandwidth communication devices, e.g., floppy disk drive, printer, mouse, keyboard, infrared communication port, etc. Secondary I/O 206 receives power from the computer system power source in an auxiliary manner, e.g., auxiliary power, such that the secondary I/O receives power during a time period that I/O controller hub 108 is not powered, e.g., during a time period that the computer system is in an off or S5 state. Because secondary I/O 206 continues to receive power if I/O controller hub 108 is not powered, the secondary I/O is able to continue to generate a signal through a computer system 200 restart. In some embodiments, secondary I/O 206 receives power from a secondary power source different from I/O controller hub 204. Secondary I/O 206 further comprises a lock status memory 208. Lock status memory 208 content is retained across computer system 200 restarts and represents the status of access to NV memory 114. Secondary I/O 206 drives a signal along an output line 210 based on the content of lock status memory 208. Secondary I/O 206 continues to drive the lock status memory 208 content-based signal across system restarts.

If lock status memory 208 content indicates a locked status, secondary I/O 206 drives a corresponding signal along output line 210 causing GP I/O 110, and thereby I/O controller hub 204, to receive a locked status signal via input line 112₁. If lock status memory 208 content indicates an unlocked status, secondary I/O 206 drives a corresponding unlock signal along output line 210 causing GP I/O 110 to receive an unlocked status signal via input line 112₁.

Because I/O controller hub 204, via communication with GP I/O 110, reads input line 112₁ at startup time and prior to reading descriptor table 116 from NV memory 114, secondary I/O 206 driving output line 210 according to the content of lock status memory 208 provides a mechanism for locking and unlocking access to NV memory 114. Secondary I/O 206 drives the lock status signal along output line 210 during system restarts without having to reread the lock status memory 208 content.

In at least one embodiment, access to lock status memory 208 is controlled in conjunction with computer system 200 setup parameters stored in NV memory 114, e.g., a password-protected portion of NV memory 114. For example, a password-protected embodiment might comprise an additional setup parameter accessible via a password-protected complementary metal oxide semiconductor (CMOS) chip setup or similar mechanism, e.g., an F10 setup option.

In operation and with lock status memory 208 content set to a locked value, a user starts, i.e., boots or reboots/restarts, computer system 200 and I/O controller hub 204 reads a locked value on input line 112₁ from GP I/O 110. Based on the read locked value, I/O controller hub 204 reads access rights stored in descriptor table 116 in order to determine whether access is to be granted to requesting components. I/O controller hub 204 also reads instructions, e.g., basic input/output system (BIOS) instructions, from NV memory 114 specifying operation of computer system 200. The user provides a predetermined input, e.g., presses a predetermined key sequence such as F10, to computer system 200 invoking a request to modify a region of NV memory 114. Responsive to the user input, processor 104 executes the instructions read from NV memory 114 by I/O controller hub 204 to cause the computer system 200 to receive user input specifying a modification of lock status memory 208 from a locked state to an unlocked state. Modifying lock status memory 208 causes secondary I/O 206 to drive an unlock signal along output line 210 to input line 112₁.

In some embodiments, user input of a password may be required by computer system 200 prior to allowing the user access to NV memory 114 parameters, e.g., to modify the lock status memory 208 content.

After modification of lock status memory 208 to the unlocked state, the user restarts computer system 200. In some embodiments, computer system 200 restarts after the user completes modification of NV memory 114 parameters and/or lock status memory 208. Removal of power from and subsequent application of power to I/O controller hub 204 during restart of computer system 200 causes the I/O controller hub to reread the signal on input line 112₁.

Because I/O controller hub 204 reads the unlock signal, the I/O controller hub does not read the access rights specified in descriptor table 116. The user is able to access, e.g., by providing the predetermined input, and modify regions of NV memory 114 without I/O controller hub 204 determining whether the access is to be allowed based on the access rights specified in descriptor table 116. For example, a user may modify or replace one or more portions of NV memory 114 in order to provide new or revised functionality to one or more components of computer system 200.

After access to NV memory 114 is complete, the user provides input to modify the lock status memory 208 content to specify a locked status. Modifying lock status memory 208 causes secondary I/O 206 to drive a lock signal along output line 210 to input line 112₁. Computer system 200 is restarted causing I/O controller hub 204 to reread input line 112₁ and determine that access to regions of NV memory 114 are to be granted based on the access rights specified in descriptor table 116.

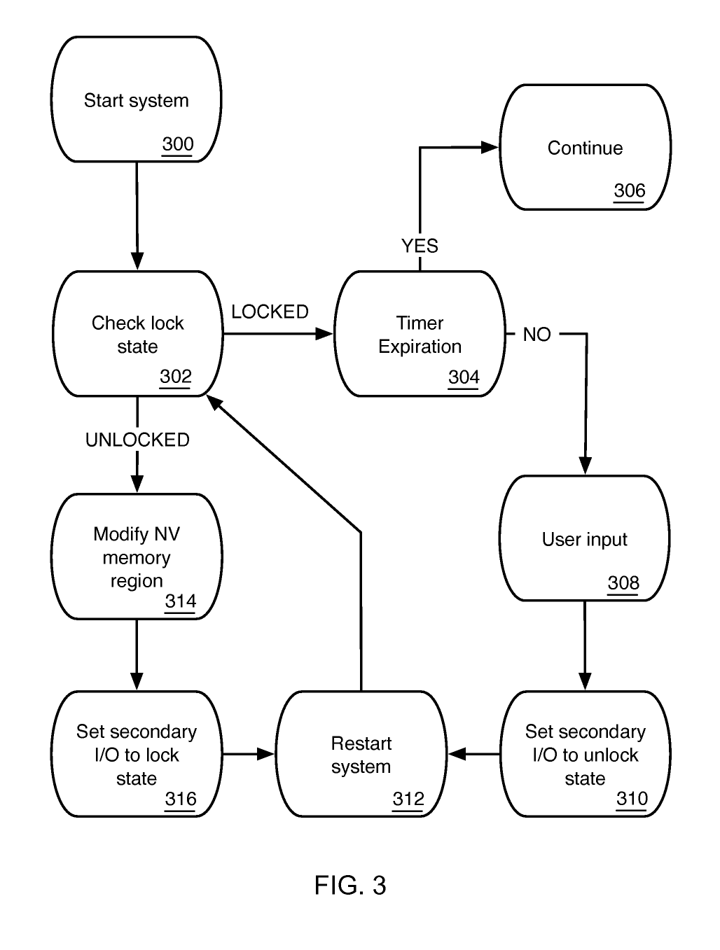

FIG. 3 depicts a high level functional process flow diagram for instruction execution by processor 104 according to embodiments consistent with FIG. 2 in which a user gains access to NV memory 114 in a computer system 200 with NV memory in an initially locked state, i.e., lock state memory 208 content indicates a locked state causing secondary I/O 206 to drive a lock signal along output line 210 to input line 112₁. The flow begins at a start function 300 wherein computer system 200 is started and the flow proceeds to a check lock state function 302.

During check lock state function 302, I/O controller hub 204 determines, by reading input line 112₁, whether NV memory 114 is in a locked or unlocked state. If a lock signal is read from input line 112₁, NV memory 114 is in a locked state and the flow proceeds to a timer expiration function 304.

During timer expiration function 304, computer system 200 determines whether a predetermined user input is received. If the predetermined user input is not received prior to expiration of a timer, the flow proceeds (“YES” path) to continue function 306 and the computer system continues the startup process, i.e., the computer system boots. In some embodiments, a second predetermined user input may be received prior to expiration of the timer to cause the flow to proceed to continue step 306 without waiting for the timer to expire.

If the predetermined user input is received prior to expiration of the timer, the flow proceeds (“NO” path) to user input function 308. During user input function 308, the user provides input to computer system 200 to enable modification of lock state memory 208 content. In some embodiments, user input function 308 requests the user to provide a password to obtain access to lock state memory 208. The flow proceeds to set unlock state function 310.

During set unlock state function 310 and responsive to user input, lock state memory 208 content is modified from the locked state to the unlocked state. Responsive to the modification of lock state memory 208, secondary I/O 206 drives an unlock signal along output line 210 and thereby along the connected input line 112₁. The flow proceeds to restart function 312 and computer system 200 restarts.

Returning to check lock state function 302, if an unlock signal is read from input line 112₁, NV memory 114 is in an unlocked state and the flow proceeds to modify NV memory function 314. In some embodiments, a user input may be required to cause the flow to proceed to modify NV memory function 314, e.g., the user invokes a setup. In some further embodiments, a user input of a password may be required for the flow to proceed to modify NV memory function 314. If an incorrect password is supplied, the flow may proceed to continue function 306.

During modify NV memory function 314, regions of NV memory 114 may be modified. In some embodiments, the user modifies NV memory 114 regions directly. In some other embodiments, the user causes execution of a sequence of instructions to modify NV memory 114 regions. The flow proceeds to set lock state function 316.

During set lock state function 316 and responsive to user input, lock state memory 208 content is modified from the unlocked state to the locked state. Responsive to the modification of lock state memory 208, secondary I/O 206 drives a lock signal along output line 210 and thereby along the connected input line 112₁. The flow proceeds to restart function 312 and computer system 200 restarts. The flow returns to check lock state function 302.

In some embodiments, modification of lock state memory content 208 during either set lock state function 310 or set unlock state function 316 causes activation of a timer which, upon expiration, causes the flow to proceed to restart function 312. In some embodiments, timer expiration function 304 may be omitted and user input function 308 determines whether to proceed to continue function 306 or set unlock state function 310 based on received user input.

What is claimed is:

1. A method of controlling access to a memory region in memory, comprising:
driving an unlock signal to an input line based on an unlocked value in a lock state memory;
restarting a computer system after writing an unlocked value to a lock state memory;
reading the unlocked value from the input line; and
enabling access to a memory region based on the read unlocked value.

2. The method of claim 1, further comprising:
restarting the computer system after writing a locked value to the lock state memory after the enabling access.

3. The method of claim 2, further comprising:
driving a lock signal to the input line based on the locked value in the lock state memory; and
reading the locked value from the input line and enabling access to the memory region based on an access right stored in the memory region.

4. The method of claim 1, wherein the enabling access comprises reading an access right from the memory and enabling access to the memory region without relying on the access right.

5. The method of claim 1, further comprising:
receiving a predetermined input prior to the enabling access to the memory region.

6. The method of claim 5, wherein the predetermined input is a password.

7. The method of claim 5, wherein the enabling access further comprises enabling access based on the predetermined input matching a predetermined value and the read unlocked value.

8. The method of claim 1, further comprising requesting user input for a predetermined time period prior to the enabling access.

9. The method of claim 1, wherein the signal driven to the input line remains the same across the computer system restart.

10. A method of controlling access to a memory region, comprising:
writing an unlocked value to a lock state memory of a computer system;
enabling access to a memory region based on reading an unlock signal at an input line driven based on the written unlocked value after removal of power from the computer system for a predetermined time and subsequent application of power to the computer system.

11. The method of claim 10, wherein the predetermined time is a restart time.

12. The method of claim 10, further comprising:
writing a locked value to the lock state memory of the computer system.

13. The method of claim 12, further comprising:
disabling access to the memory region based on reading a lock signal at the input line driven based on the written locked value after removal of power from the computer system for a predetermined time and subsequent application of power to the computer system.

14. The method of claim 13, further comprising:
enabling access to the memory region based on reading one or more access rights specifying access to the memory region.

15. A controller for controlling access to a memory region, comprising:
a memory storing one or more access rights;
an input/output controller connected to the memory and arranged to control access to the memory based on one or more of the access rights and a state of the memory;
a first input/output device connected to the input/output controller and comprising an input line arranged to receive an input signal;
a second input/output device connected to the input/output controller and comprising:
a lock state memory storing a state value representative of the state of the memory; and
an output line arranged to drive an output signal representative of the stored state value; and
wherein the input/output controller is arranged to: (i) enable access to the memory based on receipt of the output signal indicating that the memory is in an unlocked state and (ii) enable access to the memory based on one or more of the access rights based on receipt of the output signal indicating that the memory is in a locked state.

16. The controller of claim 15, wherein the memory stores the one or more access rights in a descriptor table.

17. The controller of claim 15, wherein the first input/output device is a general purpose input/output.

18. The controller of claim 15, wherein the second input/output device is a super input/output.

19. The controller of claim 15, wherein the first input/output device is connected to the second input/output device.

20. The controller of claim 15, wherein the output line is connected to the input line.
